(19) United States
(12) Patent Application Publication
(10) Pub. No.: US 2001/0032669 A1
(43) Pub. Date: Oct. 25, 2001

(54) Automatic drain valve with pneumatic actuation

(75) Inventors: William C. Stumphauzer, Elyria, OH (US); Hugh F. Groth, Richfield, OH (US)

Correspondence Address: PAUL E. MILLIKEN, 9061 WALL STREET, NW, MASSILLON, OH, 44646-1676, US

(73) Assignee: Precision Pneumatics, LLC

(21) Appl. No.: 09/794,843

(22) Filed: Feb. 27, 2001

Related U.S. Application Data
(60) Provisional application No. 60/185,255, filed on Feb. 28, 2000.

(51) Int. Cl. F16T 1/20

(52) U.S. Cl. 137/195

(57) ABSTRACT

A float actuated drain system for reservoirs containing pressurized air and/or liquids such as drain valves for traps used in the accumulation of condensate materials from pneumatic systems opens and closes a drain valve depending upon the water level in the reservoir. The drain valve uses internal pressure released from within the reservoir through a normally closed orifice and passing through a tube to operate a drain valve actuator. A lever pivotally mounted inside the reservoir has a float on one end and a stopper on the opposite end which closes the orifice when the liquid level in the reservoir is low and which moves away from the orifice when the fluid reaches a high level in the reservoir to release pressure through the orifice to operate the valve actuator and open the drain valve. After the liquid drains from the reservoir, the float moves to a lower position and the stopper closes the orifice.

### CROSS-REFERENCES TO RELATED APPLICATIONS

This application claims the benefit of U.S. Provisional Application Ser. No. 60/185,255, filed Feb. 28, 2000.

### FIELD OF THE INVENTION

This invention relates generally to automatic float-actuated drain systems for reservoirs containing pressurized air or liquids, and more particularly to an automatic drain valve for traps used in the accumulation of condensable materials and other contaminants from pneumatic systems and the like which valve utilizes internal pressure released from within the reservoir to operate a valve actuator.

### BACKGROUND OF THE INVENTION

Various types of drain systems with automatic valves have been devised to discharge accumulated water and other condensable liquids from pressurized air lines and the like. Examples of such devices are shown in U.S. Pat. No. 3,993,090 issued to Paul M Hankinson, and in U.S. Pat. Nos. 4,444,217, 4,562,855 and 4,574,829 all of which are issued to Ernie W Cummings and Nick Valk. All the above patents disclose the use of magnetic coupling members within a reservoir which translate the movement of a float with the reservoir to open and close a pilot valve which in turn causes the opening and closing of a drain valve.

A problem can occur in the devices described in the above patents when the magnetic coupling members and related moving parts become coated with corrosion or other deposits of contaminates which may be present in the water. corrosion or other deposits of contaminates which may be present in the water. Such accumulations can cause a failure of the float to raise properly or the pilot valve may stick in either the open or closed position.

U.S. Pat. No. 5,417,237 issued to William C Stumphauzer, the inventor of the present invention, and Hugh F Groth eliminated the need for magnetic coupling devices which may be prone to sticking. The device of U.S. Pat. No. 5,417,237 was further improved by U.S. Pat. No. 5,687,754 issued to Leonard R Nemeth, William S Stumphauzer, and Hugh F Groth which device provides a means of automatically injecting a positive internal pressure into the water collecting reservoir to rapidly expel water from the reservoir through the drain valve when the valve is automatically opened.

### OBJECTS OF THE INVENTION

An object of this invention is to provide an automatic float actuated drain valve for a reservoir which requires no pilot air from an outside source but uses internal air pressure taken from inside the reservoir to activate the drain valve actuator.

Another object of the invention is to provide an automatic float actuated drain valve for a reservoir which has no air loss from the system during opening and closing of the valve.

Still another object of the invention is to provide an automatic float actuated drain valve for a reservoir which operates over a wide pressure range.

A still further object of the invention is to provide an automatic float actuated drain valve for a reservoir which uses a minimum number of moving parts located within the reservoir.

These and other objects of the invention will become more fully apparent in the following description and the attached drawings.

### SUMMARY OF THE INVENTION

This invention is an automatic drain valve system for reservoirs containing pressurized air or liquids comprising: a reservoir provided with an inlet opening and an outlet drain, a pneumatic valve operator mounted externally of the reservoir and attached to said drain valve for opening and closing the valve, a buoyant float positioned within the reservoir responsive to liquid level in the reservoir to move between a high position and a low position with the reservoir, a normally closed orifice in an upper portion of the reservoir, a pivotally mounted actuation lever means having a first end operatively connected to stopper that seals the orifice inside the reservoir and having a second end operatively connected to a float positioned in the upper portion of the reservoir, pneumatic means connected between the normally closed orifice and the drain valve operator to cause the drain valve operator to open the drain valve when the orifice stopper is moved to a open position by the float rising to a higher position in the reservoir, and to close the drain valve when the normally closed orifice is sealed by the stopper by the float sinking to a low position in the reservoir.

### DESCRIPTION OF THE DRAWINGS

FIG. 1 is a vertical cross-sectional view of a reservoir using the invention taken on line 1-1 of FIG. 2;

FIG. 2 is a top plan view of the reservoir of the invention with the external actuator and drain valve for the reservoir;

FIG. 3 is a bottom view of the reservoir;

FIG. 4 is a partial vertical cross-sectional view of the reservoir of the invention similar to FIG. 1 but showing the pilot valve in the open position to release pressure into the drain valve actuator to open the drain valve; and

FIG. 5 is a horizontal cross-sectional view of the reservoir of the invention taken on line 5-5 of FIG. 4.

### DETAILED DESCRIPTION OF THE INVENTION

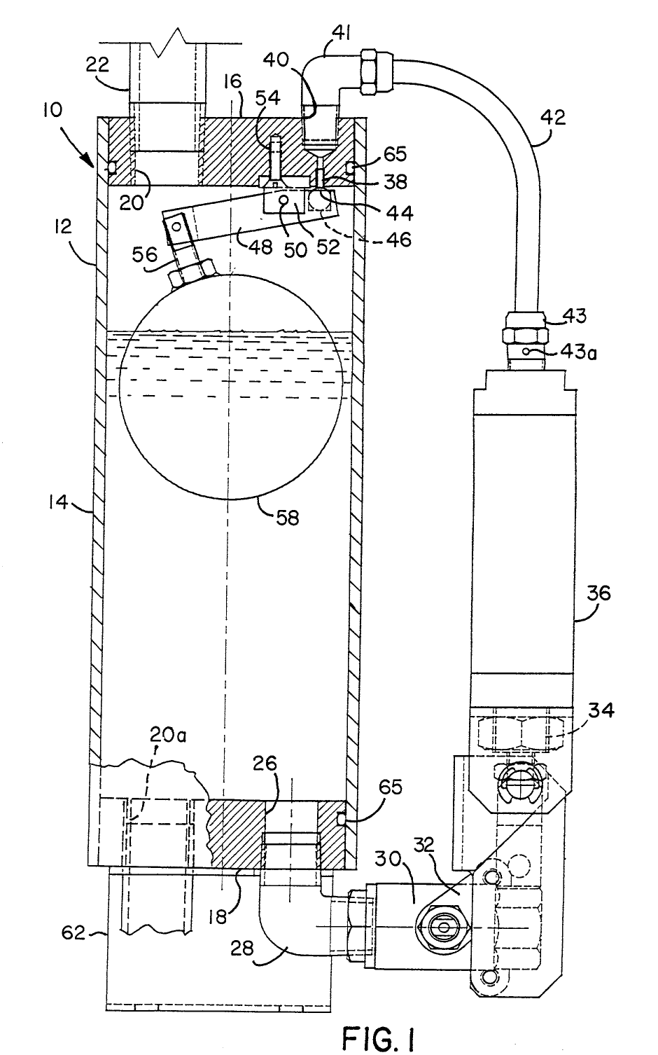

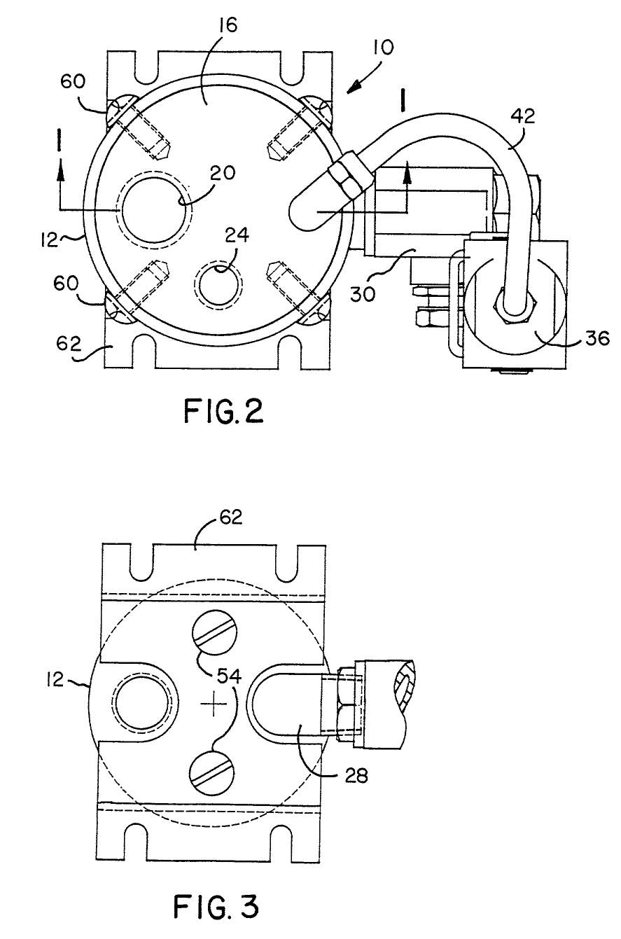

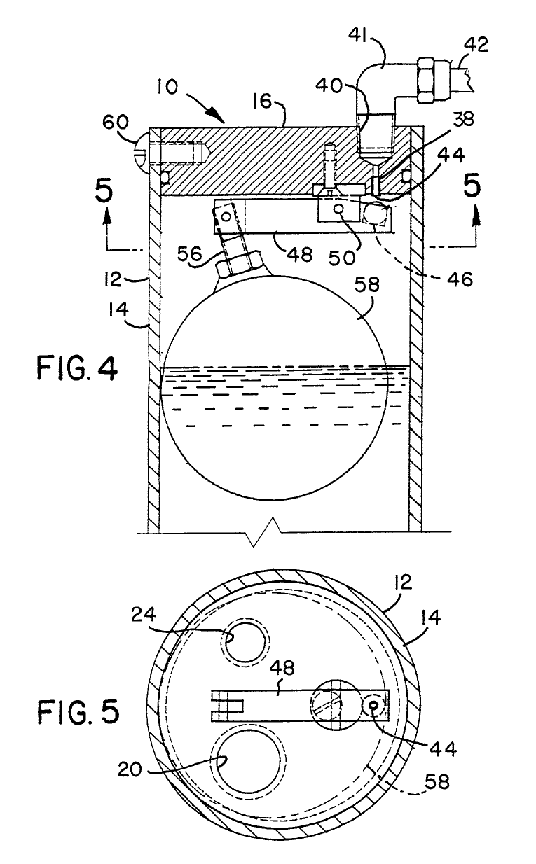

Referring now to the drawings as shown in FIGS. 1 through 5, a liquid accumulation reservoir assembly for a pneumatic system is indicated generally by the numeral 10.

The reservoir assembly 10 has a reservoir 12 which is formed from a cylindrical sidewall 14, a top 16 and a bottom 18 which are formed as thick disk shaped members which may differ from each other in the hole locations in the top 16 and bottom 18. The top 16 has an inlet port 20 which receives an inlet line 22 which permits condensed liquid to drain into the reservoir 12 along with compressed air from a source (not shown). The bottom 18 may also have an optional inlet port 20a if desired.

The top also has a restricted vent port 24 which permits escape of a small amount of air pressure from the reservoir 12 to enable liquid to flow into the reservoir 12 through the inlet port 20.

An outlet drain port 26 is located in the bottom 18 to drain water from the reservoir 12 periodically. The drain port 26 is connected to a drain line 28 in which is located a valve 30 which is opened and closed by a valve arm 32. The valve arm 32 is operated by a piston rod 34 and a piston not shown inside a pneumatic actuator 36 which is mounted in fixed relationship to the valve 30. The valve 30 is biased in a normally closed position unless opened by the piston rod 34 moving the valve arm 32 to open the valve 30.

In the top 16 of the reservoir 12 a pilot valve 38 connects through a pilot valve outlet port 40 connected through a fitting 41, a line 42 and a fitting 43 to actuator 36. The fitting 43 has a calibrated vent orifice 43a for release of air pressure to permit a timed retraction of the piston rod 34. The pilot valve 38 has a normally closed orifice 44 which communicates with the outlet port 40. A stopper or ball 46 carried on one end of a toggle arm 48 normally closes the orifice 44.

The toggle arm 48 is attached by pivot 50 to a bracket 52 which is fastened to the bottom side of the top 16 by a screw 54. The opposite end of the toggle arm 48 has one end of a stem 56 pivotally attached thereto and the opposite end of the stem 56 attached to a float 58.

As shown in FIG. 1, the top 16 is fastened to the sidewall 14 by a plurality of screws. The bottom 18 can also be fastened to the sidewall 14 by similar screws (not shown).

A base 62 is attached to the bottom 18 by screws 64.

Both the top 16 and bottom 18 are sealed with the sidewall 14 by O-rings 65 to maintain pressure within the reservoir 12.

In operation, an operating pressure of 65 to 120 psi. is maintained within the reservoir 12. Water or other condensate liquid rises in the reservoir 12 around the float 58. As water or other condensate liquids rise around the float 58 its buoyancy force continues to increase until the force exerted by float 58 on toggle arm 48 exceeds the closing force created by pressure on the ball 46. When the float buoyancy force increases beyond the ball closing force, the float lifts the toggle arm 48 causing the ball 46 on the opposite end of the toggle arm 48 to move down from the pilot hole or orifice 44 releasing air pressure through the pilot outlet port 40 and through line 42 to the pneumatic actuator 36. This causes the piston rod 34 to move the valve arm 32 to open the valve and release liquid from the reservoir 12. When the liquid level falls below the natural buoyancy level of the float 58, the ball 46 reseats over the pilot hole or orifice 44 and closes off the air supply the the actuator cylinder 36. The cylinder retraction time is governed by the calibrated vent orifice 43a in the fitting 43.

The closure of the valve 30 is timed to leave a 1″ water seal above the outlet drain port 26 at 100 psi. So no air is lost during each drain cycle.

It should be emphasized that this present system does not require pilot air to be drawn from an outside source but uses the pressure released from within the reservoir 12 to operate the actuator cylinder 36 and open the valve.

Various other modifications can be made in the system shown and described herein without departing from the scope of the invention.

We claim:

1. An automatic drain valve system for reservoirs containing pressurized air or liquids comprising:
a reservoir provided with an inlet opening and an outlet opening,
a drain valve for the reservoir mounted externally of the reservoir and connected to the outlet drain;
a pneumatic valve operator mounted externally of the reservoir and attached to the drain valve for opening and closing the valve;
a buoyant float positioned withing the reservoir responsive to liquid level in the reservoir to move between a high position and a low position with the reservoir;
a normally closed orifice in an upper portion of the reservoir;
a pivotally mounted actuation lever means having a first end operatively connected to a stopper that seals the orifice inside the reservoir and having a second end operatively connected to a float positioned in the upper portion of the reservoir; and
pneumatic means connected between the normally closed orifice and the drain valve operator to cause the drain valve operator to open the drain valve when the orifice stopper is moved to an open position by the float rising to a higher position in the reservoir, and to close the drain valve when the normally closed orifice is sealed by the stopper when the float sinks to a low position in the reservoir.

2. The drain valve system claimed in claim 1 wherein the actuation lever means extends downwardly to a position near the upper one-third of the reservoir.

3. The drain valve system claimed in claim 1 in which the ration of float diameter to orifice diameter is at least twenty times greater than the leverage ratio of the float to the orifice stopper.

4. The drain valve system claimed in claim 1 wherein the outlet drain is located in the bottom of the reservoir.

5. The drain valve system claimed in claim 1 wherein the inlet opening is located at the bottom of the reservoir.

6. The drain valve claimed in claim 1 wherein the normally closed orifice is located in the top of the reservoir.

7. The drain valve system claimed in claim 1 wherein the drain valve is located in close proximity to the bottom of the reservoir.

8. An automatic outlet drain valve system for reservoirs for accumulating liquids in a pneumatic system comprising:
a reservoir having a top, a bottom and sidewall means extending therebetween, the reservoir having an inlet opening and outlet opening connected to a pneumatic system and said reservoir having a drain in the bottom thereof;
a drain valve for the reservoir mounted externally of the reservoir and connected to the outlet drain;
a pneumatic valve operator mounted externally of said reservoir and attached to the drain valve for opening and closing the valve;
a buoyant float positioned within the reservoir responsive to liquid level in the reservoir to move between a high position and a low position within the reservoir;
a normally closed orifice positioned in the top of the reservoir;
actuation lever means having a first end operatively connected to a stopper that normally seals the orifice and having a second end positioned near the upper one-third of the reservoir when the float is in a low position within the reservoir; and
pneumatic means connected between the orifice and the valve operator to cause the valve operator to open the drain valve when the orifice is opened by the float rising to a high position in the reservoir, and to close the drain valve when the orifice is closed by the float sinking to a low position in the reservoir.
